(19) United States
(12) Patent Application Publication
(10) Pub. No.: US 2012/0025718 A1
(43) Pub. Date: Feb. 2, 2012

(54) LIGHTING APPARATUS

(76) Inventor: Yoeng-Cheol Yoon, Gyeonggi-do (KR)

(21) Appl. No.: 13/263,078

(22) PCT Filed: Apr. 20, 2010
(86) PCT No.: PCT/KR10/02474

§ 371 Date: Oct. 5, 2011

(30) Foreign Application Priority Data
Apr. 27, 2009 (JP) 20-2009-0005029

(51) Int. Cl. H05B 37/02

(52) U.S. Cl. 315/158

(57) ABSTRACT

The present design relates to a lighting apparatus which ensures consistent illumination of constant brightness during darkness or in unlit areas. The lighting apparatus comprises: a lamp unit including a plurality of main lamps and a plurality of auxiliary lamps; a detection sensor unit composed of a sensor for detecting a motion of an object; and a controller for controlling operations of the lamp unit and the sensor unit, wherein the auxiliary lamp is adapted to stay turned on at all times, and the main lamp, which operates independently of the auxiliary lamp, is adapted to be turned on if the detection sensor detects a signal, and the controller is adapted to control ON/OFF of the lamp unit according to a signal detected by the detection sensor and to adjust brightness of the entire lamp unit. While the auxiliary lamps stay turned on all the time, the plurality of main lamps are turned on only if the detection sensor detects a signal and are turned off sequentially if a signal for an object in motion is no longer detected. Accordingly, a lighting configuration of constant brightness is consistently provided during darkness or in unlighted areas. This configuration prevents accidents and alleviates feelings of insecurity for persons moving about in a building.

### TECHNICAL FIELD

The present invention relates, in general, to a lighting apparatus for use in the office, a passageway, a stairway, or a parking lot, and more particularly to, a lighting apparatus which always produces a predetermined amount of light in a dark time or site.

### BACKGROUND ART

Currently available lighting apparatuses are actuated in such a manner as to be turned on only when a motion of an object is detected at the night, and to be turned off when the object moves out of the detection range. FIG. 1 shows a conventional lighting apparatus, in which a sensor lamp unit that will be turned on for a few minutes in response to the operation of a detection sensor 12 such as an illumination sensor, a superconductive sensor, or an ultrasonic sensor, which is mounted in the entrance or passageway, is disposed in a main body 11 while being covered with a cover 12 at the center of the main body. Here, the detection sensor protrudes from the side of the main body in order to detect a passer-by. However, such a conventional lighting apparatus is turned on only when a passer-by is within a detection range, so that if a passer-by does not yet enter the detection range, or otherwise if he/she does not yet move out of the detection range, he/she is in the dark and may feel uneasy, thereby possibly causing safety accidents as well as striking a psychological nervousness to passers-by.

### DISCLOSURE

### Technical Problem

Accordingly, the present invention has been made keeping in mind the above problems occurring in the related art, and an objective of the present invention is to provide a lighting apparatus which always produces a predetermined amount of light in a dark time or site, and if a motion of an object is detected, produces a maximum amount of light.

### Technical Solution

In order to achieve the above object, according to one aspect of the present invention, there is provided a lighting apparatus including:

a lamp unit having a plurality of main lamps and auxiliary lamps;

a sensor unit having a detection sensor detecting a motion of an object; and

a controller controlling the operation of the lamp unit and sensor unit,

wherein the lamp unit is configured such that the main lamps and the auxiliary lamps are independently actuated so that the auxiliary lamps are always turned on, and the main lamps are operated in response to a motion of an object detected by the detection sensor,

wherein the controller controls the operation of the lamp unit to be turned on and off according to a detection single from the detection sensor in such a manner that the auxiliary lamps are always turned on, the main lamps are also turned on when the signal from the detection sensor is received, and if the signal from the detection sensor is not received as the detected object moves out of detection range of the detection sensor, the main lamps are sequentially turned off according to a predetermined set time, thereby regulating the brightness of the whole lamp unit while always providing a predetermined degree of brightness even in a dark time and site.

In an aspect, a lighting apparatus is provided which includes a plurality of auxiliary lamps and a controller controlling the number of the auxiliary lamps that are always turned on, thereby regulating the brightness thereof in a variety of degrees.

In an aspect, a lighting apparatus includes: a lamp unit capable of regulating the brightness thereof; a sensor unit including an illuminance sensor detecting illuminance around the lamp unit and a detection sensor detecting a motion of an object; a power supply unit supplying power to the lamp unit; and a controller controlling the operation of the lamp unit, sensor unit, and power supply unit, wherein the brightness of the lamp unit varies by the action of the controller performed to the power supply unit to regulate power to be supplied,

wherein the controller is configured to control the brightness of the whole lamp unit by regulating power supplied to the lamp unit according to signals from the illuminance sensor and detection sensor, such that if illuminance above a predetermined threshold is detected by the illuminance sensor, the lamp unit is turned off, and if illuminance below the predetermined threshold is detected by the illuminance sensor, the lamp unit is turned on in predetermined minimum brightness; if the signal from the detection sensor is received, the lamp unit is turned on in maximum brightness, and if the detection signal from the detection sensor is not received as the detected object moves out of detection range of the detection sensor, the brightness of the lamp unit is gradually decreased to the predetermined minimum brightness according to a predetermined set time, thereby regulating the brightness of the whole lamp unit while always providing a predetermined degree of brightness even in a dark time and site.

In an aspect, a lighting apparatus includes: a lamp unit capable of regulating the brightness thereof; a sensor unit including a detection sensor detecting a motion of an object; a power supply unit supplying power to the lamp unit; and a controller controlling the operation of the lamp unit, sensor unit, and power supply unit, wherein the brightness of the lamp unit varies by the action of the controller performed to the power supply unit to regulate power to be supplied,

wherein the controller is configured to control the brightness of the whole lamp unit by regulating power supplied to the lamp unit according to a signal from the detection sensor, such that the lamp unit is turned on in predetermined minimum brightness; if the signal from the detection sensor is received, the lamp unit is turned on in maximum brightness, and if the signal from the detection sensor is not received as the detected object moves out of detection range of the detection sensor, the brightness of the lamp unit is gradually decreased to the predetermined minimum brightness according to a predetermined set time, thereby regulating the brightness of the whole lamp unit while always providing a predetermined degree of brightness even in a dark time and site.

### Advantageous Effects

According to the present invention, even though an object is not detected, the lighting apparatus always provides a predetermined degree of brightness even in a dark site having illuminance below a certain threshold, thereby preventing a safety accident that may occur to passers-by when a certain place is not illuminated for some time, and also relaxing the psychological unease of the passers-by at that place.

### DESCRIPTION OF DRAWINGS

FIG. 1 is a view showing a conventional lighting apparatus.

FIG. 2 is a view showing the internal construction of a lighting apparatus according to a first embodiment of the present invention.

FIG. 3 is a view showing the internal construction of a lighting apparatus according to a second embodiment of the present invention.

FIG. 4 is a view showing the internal construction of a lighting apparatus according to a third embodiment of the present invention.

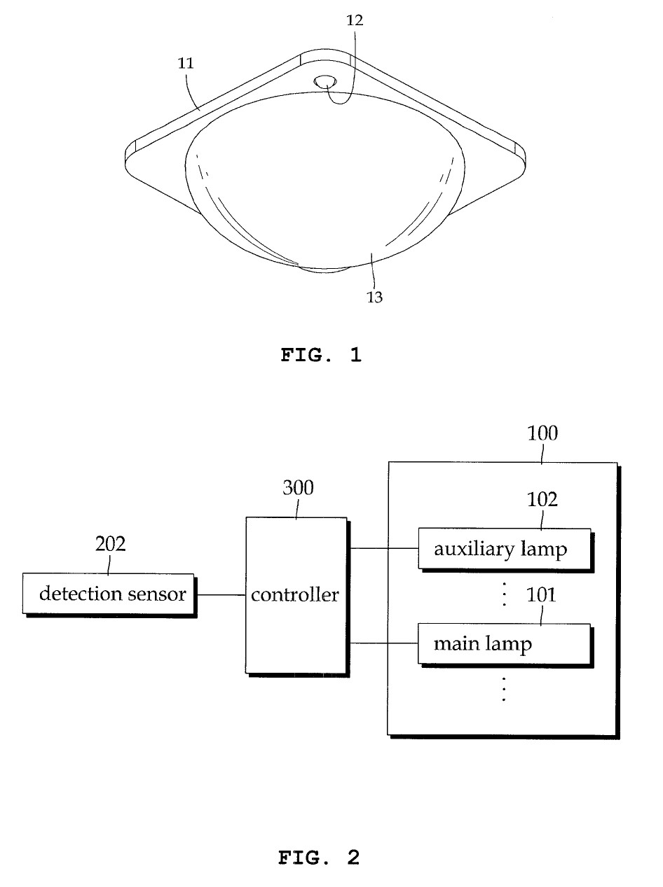

### MAJOR REFERENCE NUMERALS OF THE DRAWINGS

100: Lamp Unit 101: Main Lamp
102: Auxiliary lamp 200: Sensor Unit
201: Illuminance Sensor 202: Detection sensor
300: Controller
400: Brightness-controllable Lamp
500: Power Supply unit

### BEST MODE

Hereinafter, a description will be made in detail of a lighting apparatus according to the present invention with reference to the accompanying drawings.

FIG. 2 is a view showing the internal construction of a lighting apparatus according to a first embodiment of the present invention.

As shown in FIG. 2, the lighting apparatus according to the first embodiment of the present invention includes a lamp unit having a main lamp 101 and an auxiliary lamp 102, a detection sensor 202 that detects a motion of an object, and a controller 300 that controls the operation of the lamp unit and detection sensor.

The main lamp and auxiliary lamp 102 that constitute the lamp unit may use a variety of conventional lamps such as incandescent lamps, fluorescent lamps, halogen lamps, LEDs, or the like. The main lamp and auxiliary lamp each are composed of a plurality of lamps and are controlled by the controller.

The detection sensor 202 serves to detect a motion of an object and transmit a detection signal to the controller 300.

The controller 300 is configured to control the lamp unit to be turned on and off according to a signal from the detection sensor, thereby regulating the brightness of the whole lamp unit. The controller performs a control action in such a manner that the auxiliary lamp is always turned on, and if the signal from the detection sensor is received, the main lamp is turned on. This configuration is useful in an always-dark space such as a basement parking lot in a building, and allows that the auxiliary lamp is always turned on to maintain a constant degree of illuminance, and the main lamp is turned on or off according to the signal from the detection sensor.

If a motion of an object is detected when the auxiliary lamp is being turned on, a detection signal is transmitted from the detection sensor to the controller, which then turns on the main lamp according to the detection signal from the detection sensor, thereby providing maximum degree of illuminance thereto.

In addition, if the detection signal is not received as the detected object moves out of the detection range of the detection sensor, the main lamp is turned off, but at least the auxiliary lamp is still turned on, so that even when an object is out of the detection range of the detection sensor in a certain space, the space is still illuminated in certain degree of illuminance by the auxiliary lamp.

In the meantime, the main lamp is configured to be composed of a plurality of lamps so that the controller controls the lamp unit such that if an object is detected, the plurality of main lamps are turned on, and if the object moves out of the detection range of the detection sensor, all the main lamps are turned off not at once, but sequentially according to a predetermined time set by the controller. Thus, the control is performed such that if an object moves out of the detection range of the detection sensor, illuminance at that place can be maintained in more degrees of brightness than the case where only the auxiliary lamp is turned on, and in the case where it is estimated that the object completely moved out of the place, all the main lamps then only become turned off. That is, even when the object moves out of the detection range of the detection sensor, all the main lamps are turned off not concurrently, but sequentially according to a set time with a time lag, so that a passer-by can pass through the space with composure.

Meanwhile, the auxiliary lamp may be configured to be composed of a plurality of lamps, so that if an object is not detected, the auxiliary lamps can provide a variety of degrees of illuminance. For example, the auxiliary lamp can be configured to comprise a plurality of lamps so it is possible to set the brightness of the whole auxiliary lamps to e.g. 20%, 30%, or 50% of the maximum brightness. That is, a variety of reference thresholds for illuminance can be set, and a minimum degree of brightness can be concurrently controlled in diverse degrees.

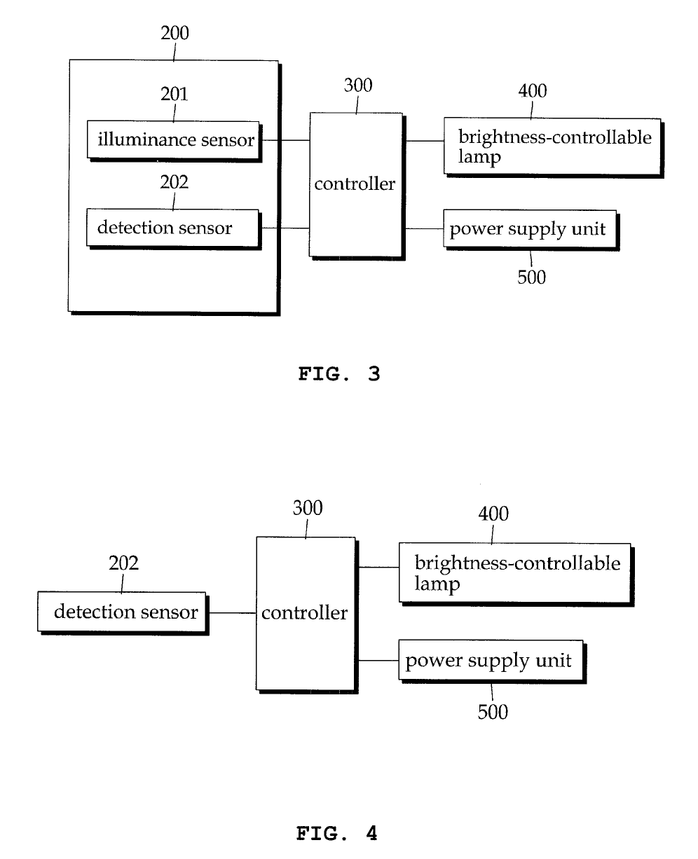

FIG. 3 is a view showing the internal construction of a lighting apparatus according to a second embodiment of the present invention.

As shown in FIG. 3, the lighting apparatus according to the second embodiment of the present invention includes a lamp unit 400 that is capable of regulating the brightness thereof, a sensor unit 200 having an illuminance sensor 201 that detects illuminance around the lamp unit and a detection sensor 202 that detects a motion of an object, a power supply unit 500 that supplies power to the lamp unit, and a controller 300 that controls the operation of the lamp unit, sensor unit, and power supply unit.

The illuminance sensor 201 serves to detect the illuminance around the circumference, and the brightness-controllable lamp unit 400 is a lamp that is capable of regulating the brightness thereof according to an amount of power supplied thereto by the power supply unit. The power supply unit 500 serves to supply power to the brightness-controllable lamp unit by the control of the controller.

The controller 300 is configured to regulate power supplied to the lamp unit according to signals from the illuminance sensor and detection sensor, thereby regulating the brightness of the whole lamp unit. The controller performs a control action in such a manner that if illuminance above a predetermined threshold is detected by the illuminance sensor, the lamp unit is turned off, and if illuminance below the predetermined threshold is detected by the illuminance sensor, the lamp unit is turned on in predetermined minimum brightness; if the signal from the detection sensor is received, the lamp unit is turned on in maximum brightness, thereby regulating the brightness of the whole lamp unit while always providing a predetermined degree of brightness even in a dark time and site.

In addition, the controller is operated such that if the detection signal from the detection sensor is not received as the detected object moves out of detection range of the detection sensor, the brightness of the lamp unit is gradually decreased to the predetermined minimum brightness according to a predetermined set time. Thus, even when an object moves out of the detection range of the detection sensor, the brightness of the lamp unit changes to the minimum brightness not concurrently, but sequentially with a time lag, so that the object such as a passer-by can safely pass through the place without safety accidents.

FIG. 4 is a view showing the internal construction of a lighting apparatus according to a third embodiment of the present invention.

As shown in FIG. 4, the lighting apparatus according to the third embodiment of the present invention includes a lamp unit 400 that is capable of regulating the brightness thereof, a sensor unit 200 having a detection sensor 202 that detects a motion of an object, a power supply unit 500 that supplies power to the lamp unit, and a controller 300 that controls the operation of the lamp unit, sensor unit, and power supply unit.

In the third embodiment, the controller is configured to regulate power supplied to the lamp unit according to a signal from the detection sensor, thereby regulating the brightness of the whole lamp unit. The controller performs a control action such that the lamp unit is always turned on in predetermined minimum brightness; and if the signal from the detection sensor is received, the lamp unit is turned on in maximum brightness, thereby regulating the brightness of the whole lamp unit while always providing a predetermined degree of brightness even in a dark site such as a basement parking lot.

In addition, like the second embodiment, the controller is operated such that if the detection signal from the detection sensor is not received as the detected object moves out of detection range of the detection sensor, the brightness of the lamp unit is gradually decreased to the predetermined minimum brightness according to a predetermined set time.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A lighting apparatus for use in offices, passageways, stairways, entrances, or basement parking lots of buildings, the lighting apparatus comprising:
a lamp unit capable of regulating the brightness thereof;
a sensor unit including an illuminance sensor detecting illuminance around the lamp unit and a detection sensor detecting a motion of an object;
a power supply unit supplying power to the lamp unit; and
a controller controlling the operation of the lamp unit, sensor unit, and power supply unit,
wherein the brightness of the lamp unit varies by the action of the controller performed to the power supply unit to regulate power to be supplied,
wherein the controller is configured to control the brightness of the lamp unit by regulating power supplied to the lamp unit according to signals from the illuminance sensor and detection sensor, such that if illuminance above a predetermined threshold is detected by the illuminance sensor, the lamp unit is turned off, and if illuminance below the predetermined threshold is detected by the illuminance sensor, the lamp unit is turned on in predetermined minimum brightness; if the signal from the detection sensor is received, the lamp unit is turned on in maximum brightness, and if the detection signal from the detection sensor is not received as the detected object moves out of detection range of the detection sensor, the brightness of the lamp unit is gradually decreased to the predetermined minimum brightness according to a predetermined set time, thereby regulating the brightness of the lamp unit while always providing a predetermined degree of brightness even in a dark time and site.

2. A lighting apparatus for use in offices, passageways, stairways, entrances, or basement parking lots of buildings, the lighting apparatus comprising:
a lamp unit capable of regulating the brightness thereof;
a sensor unit including a detection sensor detecting a motion of an object;
a power supply unit supplying power to the lamp unit; and
a controller controlling the operation of the lamp unit, sensor unit, and power supply unit,
wherein the brightness of the lamp unit varies by the action of the controller performed to the power supply unit to regulate power to be supplied,
wherein the controller is configured to control the brightness of the lamp unit by regulating power supplied to the lamp unit according to a signal from the detection sensor, such that the lamp unit is turned on in predetermined minimum brightness; if the signal from the detection sensor is received, the lamp unit is turned on in maximum brightness, and if the signal from the detection sensor is not received as the detected object moves out of detection range of the detection sensor, the brightness of the lamp unit is gradually decreased to the predetermined minimum brightness according to a predetermined set time, thereby regulating the brightness of the lamp unit while always providing a predetermined degree of brightness even in a dark time and site.
